(19) United States
(12) Patent Application Publication
(10) Pub. No.: US 2014/0342607 A1
(43) Pub. Date: Nov. 20, 2014

(54) CROSSTALK-PROOF RECEPTACLE CONNECTOR

(71) Applicant: Advanced-Connectek Inc., New Taipei City (TW)

(72) Inventors: Yao-Te WANG, New Taipei City (TW); Kuo-Ching LEE, New Taipei City (TW); Ya-Ping LIANG, New Taipei City (TW); Jian-Li GUAN, Tian-Jin (CN)

(73) Assignee: Advanced-Connectek Inc., New Taipei City (TW)

(21) Appl. No.: 14/260,695

(22) Filed: Apr. 24, 2014

(30) Foreign Application Priority Data
May 17, 2013 (CN) 201310182753.4

(51) Int. Cl. H01R 13/6461

(52) U.S. Cl. CPC H01R 13/6461
USPC 439/607.05

(57) ABSTRACT

A crosstalk-proof receptacle connector includes: multiple insulative boards arranged abreast; multiple sets of terminals mounted respectively in and corresponding to the insulative boards, and each set including signal terminals and grounding terminals; multiple shielding plates corresponding to the insulative boards and corresponding to the sets of the terminals, each shielding plate mounted on one of two opposite sides of a corresponding insulative board and having multiple current-path-interrupting holes defined through the shielding plate and kept hollow without being inserted by objects, and each shielding plate connected to the grounding terminals of a corresponding set of the terminals; and an outer casing covering the insulative boards to combine the insulative boards. The crosstalk-proof receptacle connector suppresses crosstalk and improves efficiency and stability of signal transmission.

### BACKGROUND OF THE INVENTION

1. Field of the Invention

The present invention relates to a connector, and more particularly to a crosstalk-proof receptacle connector that is able to suppress crosstalk between signal terminals.

2. Description of Related Art

Servers such as blade servers and rack mount servers have printed circuit boards (PCBs) mounted with connectors for high speed and stable signal transmission. Such high speed connectors have compactly arranged terminals for massive signal transmission. However, crosstalk usually occurs between adjacent terminals and becomes worse when the signal terminals are operated to transmit high frequency signals, which lowers the efficiency of signal transmission and even causes failure of signal transmission.

With reference to FIG. 12, to prevent the aforementioned crosstalk, an improved connector has been developed. The connector has multiple insulative boards 90, multiple metal shielding plates 92 and a casing 93. The insulative boards 90 are arranged abreast and each insulative board 90 has a set of multiple terminals 91 mounted thereon. The metal shielding plates 92 are mounted respectively on the insulative boards 90 and are arranged alternately with the insulative boards 90 so that each metal shielding plate 92 is between two adjacent sets of the terminals 91. The casing 93 covers the insulative boards 90. The aforementioned arrangement of the connector is able to prevent the signal interference between adjacent sets of the terminals 91 on two opposite sides of one metal shielding plate 92. However, the metal shielding plate 92 is a single piece with sufficient width and length and therefore provides a sufficient long and diagonal path P₀ to allow electric charges to run thereon, which causes antenna effect and additional signal interference. For example, the diagonal path P₀ on the metal shielding plate 92 is the longest path and easily causes antenna effect.

If the diagonal path on the metal shielding plate 92 can be interrupted, the antenna effect will be reduced. However, no means are implemented to the connector to cut the path of antenna effect. The following prior art disclose some improvements to connectors. However, these improvements are not to cut the path of antenna effect and therefore cannot efficiently reduce the antenna effect.

U.S. Pat. No. 7,347,740 discloses a lead frame assembly for a connector having mounting holes on terminals. Dielectric material is filled in the mounting holes and partially covers the terminal. However, the connector has no any shielding element to prevent crosstalk.

U.S. Pat. No. 7,074,086 mentions another prior art U.S. Pat. No. 6,409,543 that discloses a shielding plate with multiple through holes. The through holes allow a tool to extend through the through holes during fabrication to cut fixing bars between adjacent terminals. However, no crosstalk-proof elements are made.

U.S. Pat. No. 8,182,289 discloses a connector with a lossy insert. The lossy insert has multiple holes to be engaged with pins on a wafer. No crosstalk-proof elements are disclosed in the patent.

To overcome the shortcomings, the present invention provides a crosstalk-proof receptacle connector to mitigate or obviate the aforementioned problems.

### SUMMARY OF THE INVENTION

The main objective of the invention is to provide a receptacle connector that is able to suppress crosstalk between signal terminals.

A crosstalk-proof receptacle connector in accordance with the present invention comprises: multiple insulative boards arranged abreast; multiple sets of terminals mounted respectively in and corresponding to the insulative boards, and each set including signal terminals and grounding terminals; multiple shielding plates corresponding to the insulative boards and corresponding to the sets of the terminals, each shielding plate mounted on one of two opposite sides of a corresponding insulative board and having multiple current-path-interrupting holes defined through the shielding plate and kept hollow without being inserted by objects, and each shielding plate connected to the grounding terminals of a corresponding set of the terminals; and an outer casing covering the insulative boards to combine the insulative boards. The crosstalk-proof receptacle connector suppresses crosstalk and improves efficiency and stability of signal transmission.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a crosstalk-proof receptacle connector in accordance with the present invention;

FIG. 2 is another perspective view of the crosstalk-proof receptacle connector in FIG. 1;

FIG. 3 is a perspective view of the crosstalk-proof receptacle connector in FIG. 2 with the outer casing omitted;

FIG. 4 is an exploded perspective view of the crosstalk-proof receptacle connector in FIG. 3;

FIG. 5 is another exploded perspective view of the crosstalk-proof receptacle connector in FIG. 3;

FIG. 6 is an exploded perspective view of an insulative board, a set of terminals and a set of shielding plates of the crosstalk-proof receptacle connector in FIG. 3;

FIG. 7 is a perspective view of the terminals of the crosstalk-proof receptacle connector in FIG. 6;

FIG. 8 is a perspective view of the shielding plate of the crosstalk-proof receptacle connector in FIG. 6;

FIG. 9 is a side view of the shielding plate of the crosstalk-proof receptacle connector in FIG. 6;

FIG. 10 is a front view of the crosstalk-proof receptacle connector in FIG. 10;

FIG. 11 is a perspective view of a set of terminals and a shielding plate of another embodiment of a crosstalk-proof receptacle connector in accordance with the present invention; and

FIG. 12 is a perspective view of a conventional connector in accordance with the prior art.

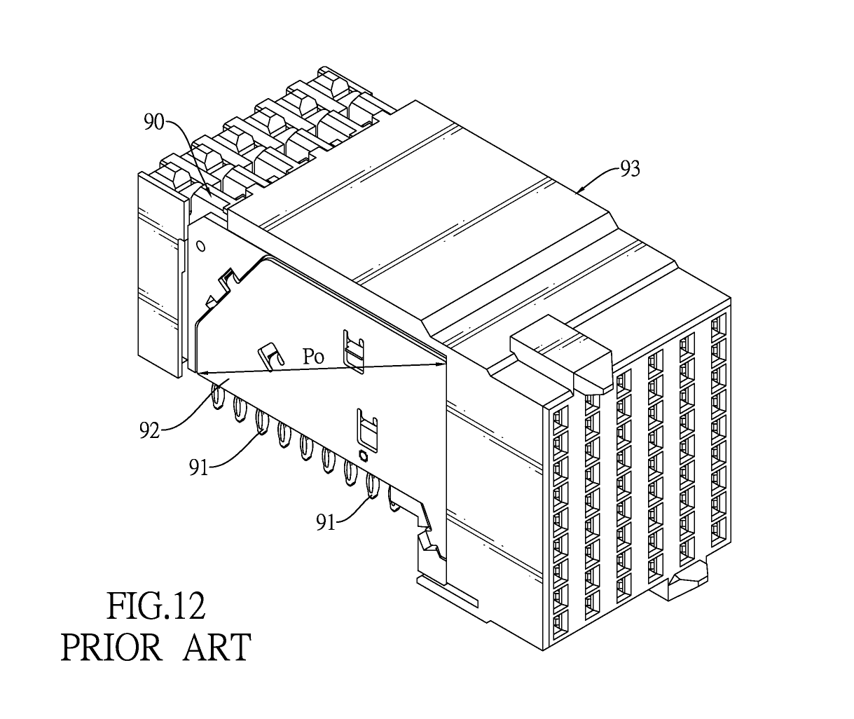

### DETAILED DESCRIPTION OF THE PREFERRED EMBODIMENT

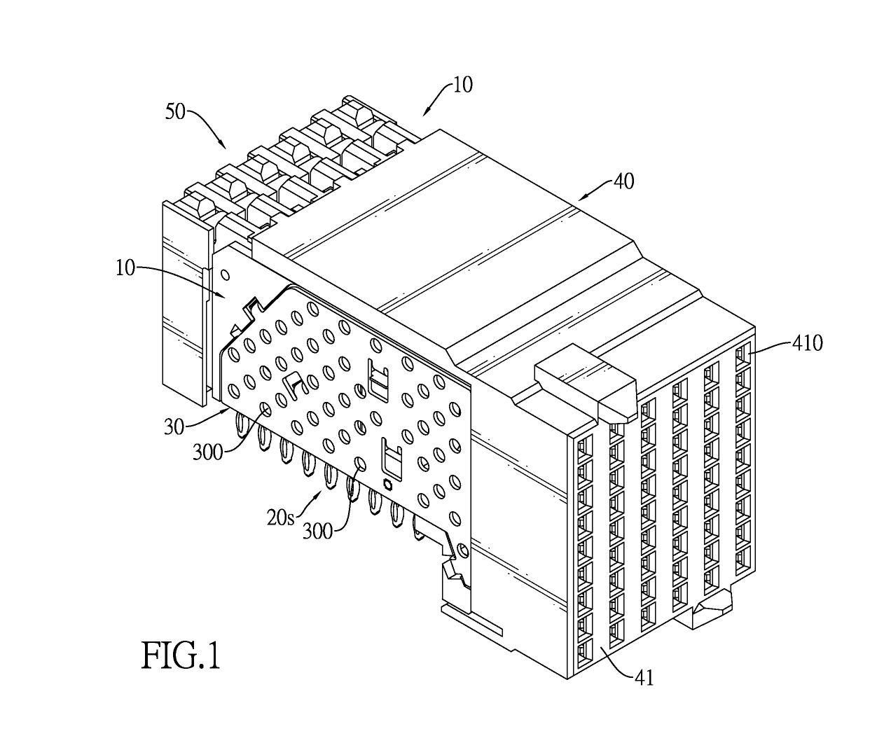

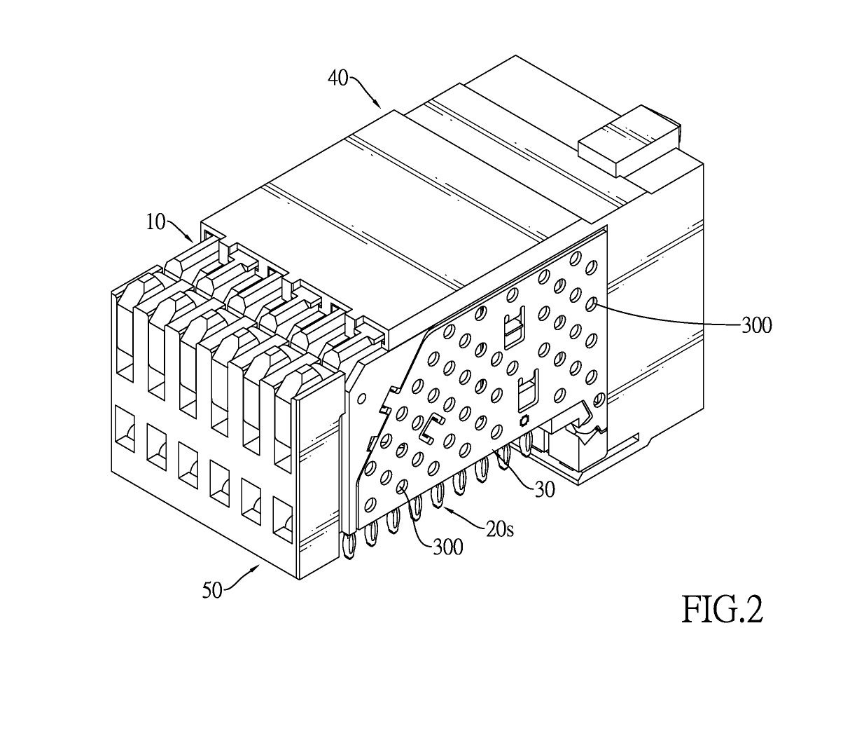

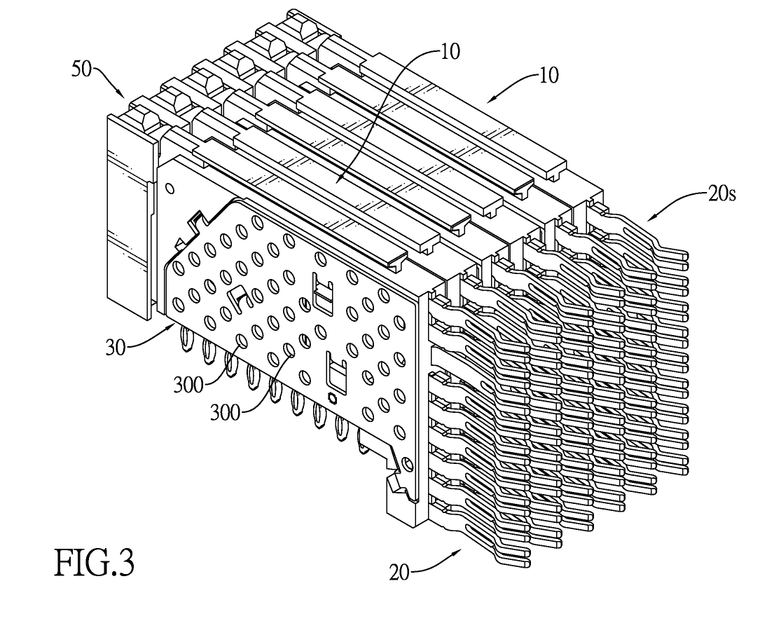

With reference to FIGS. 1 to 3, a crosstalk-proof receptacle connector in accordance with the present invention may be soldered on a PCB and comprises multiple insulative boards 10, multiple sets of terminals 20s, 20g, multiple shielding plates 30, an outer casing 40 and a rear assembling cover 50.

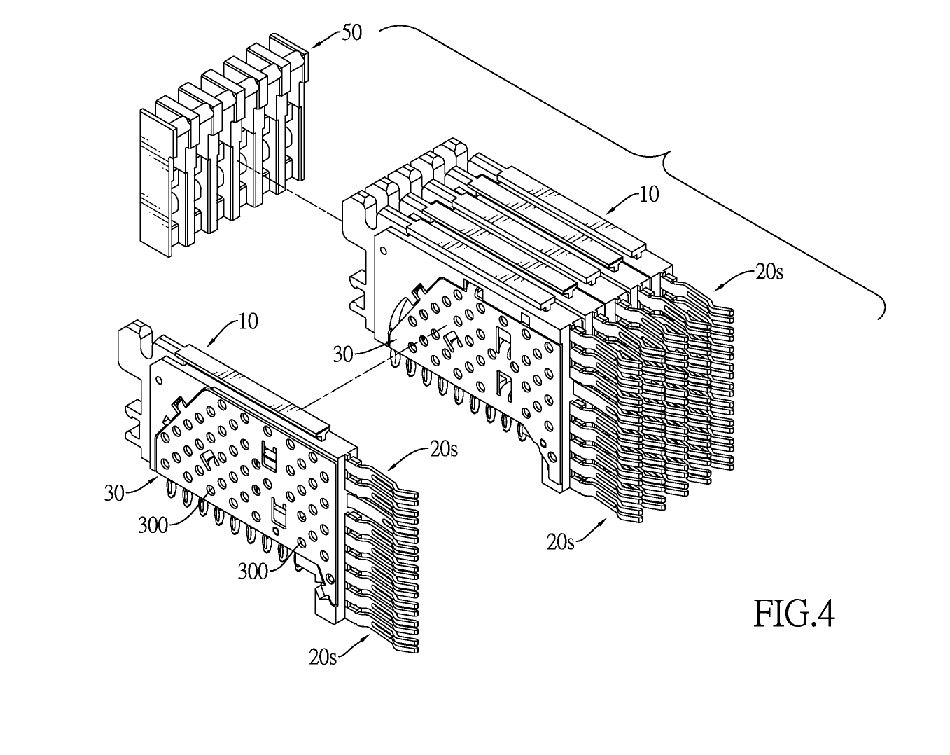

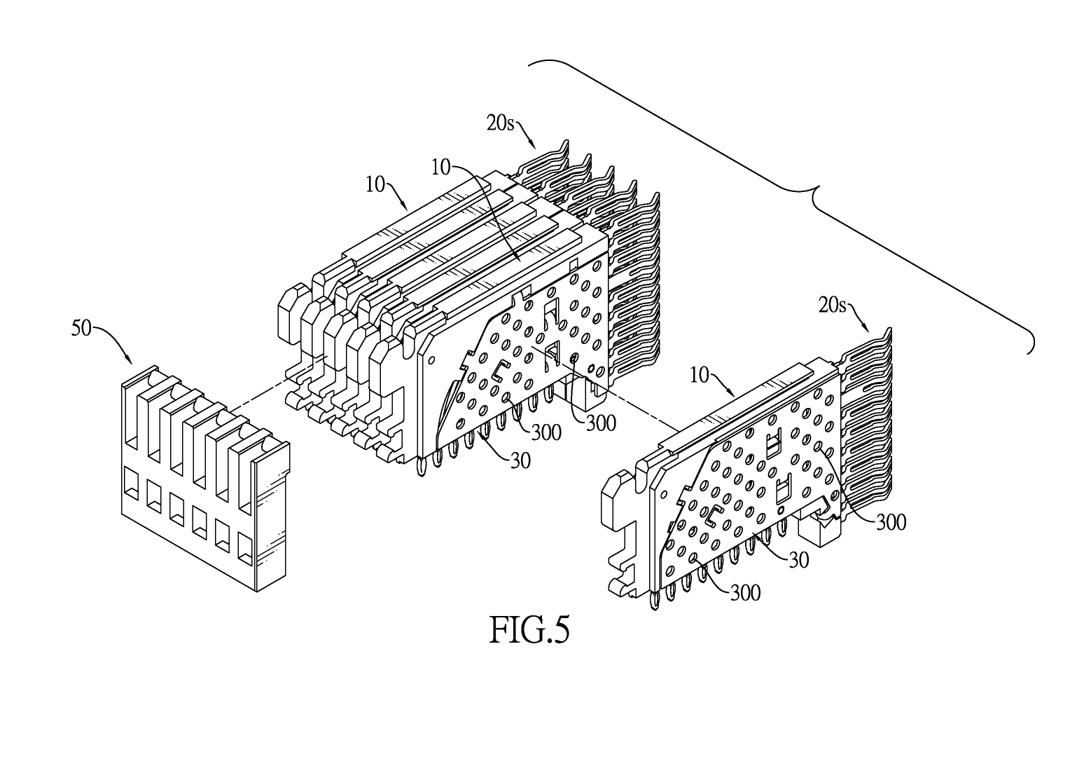

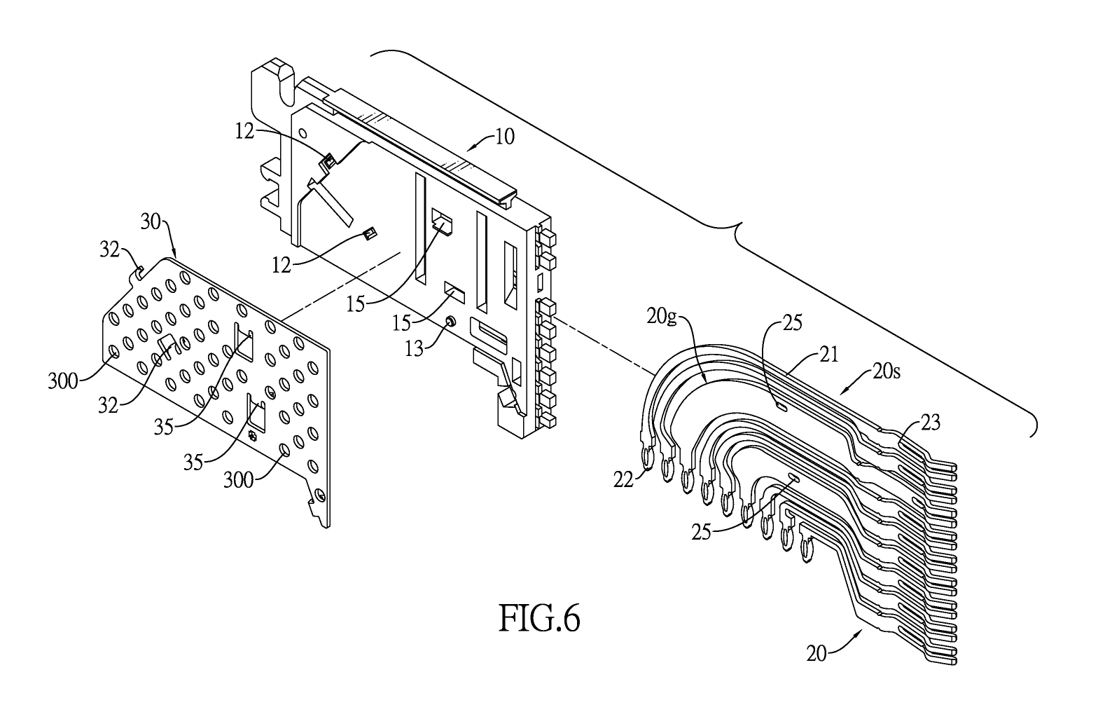

With reference to FIGS. 4 to 6, the insulative boards 10 are arranged abreast and each insulative board 10 has multiple first engaging elements 12, 13.

The first engaging elements 12, 13 are formed on the insulative board 10.

The sets of the terminals 20s, 20g are mounted respectively in and correspond to the insulative boards 10 and each set includes signal terminals 20s and grounding terminals 20g. Each signal or grounding terminal 20s, 20g has a mounting section 21, an assembling section 22 and an electrical contacting section 23.

The mounting section 21 is embedded in a corresponding insulative board 10.

The assembling section 22 is formed on and protrudes downward from the mounting section 21 and may be soldered or press-fitted on the PCB.

The electrical contacting section 23 may be forked and is formed on and protrudes forward from the mounting section 21 to electrically contact a terminal of a plug connector corresponding to the crosstalk-proof receptacle connector.

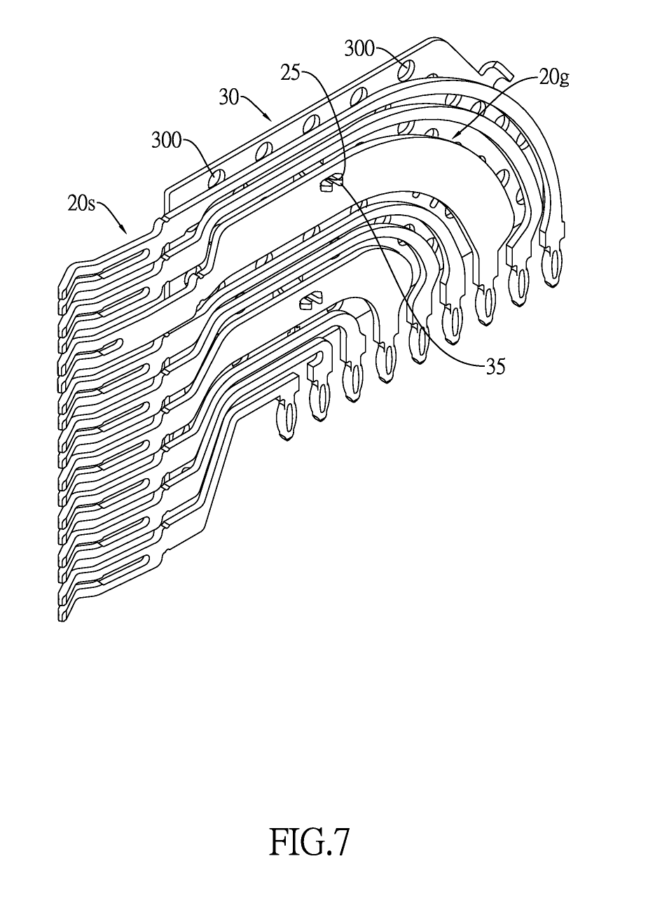

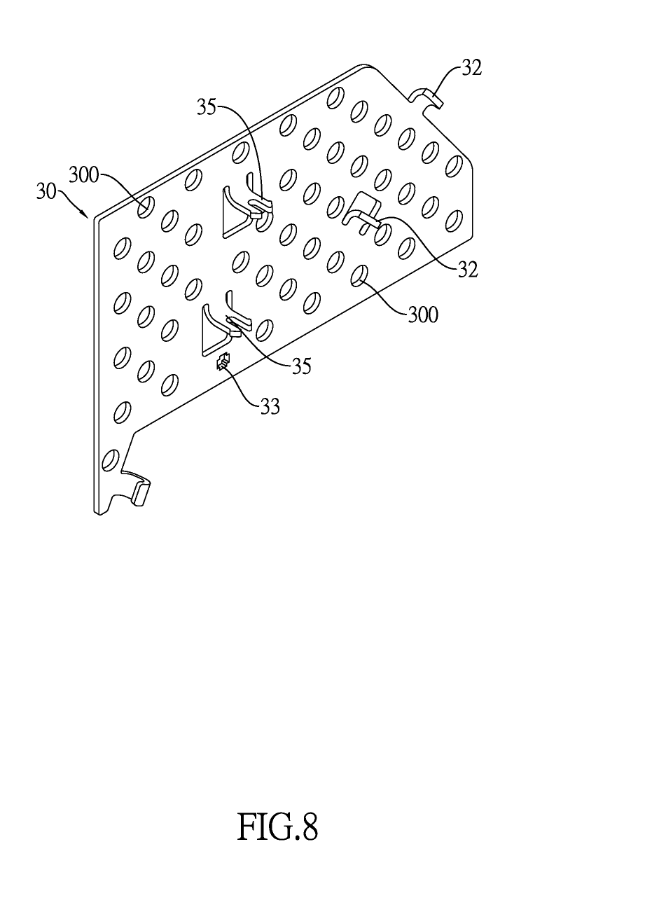

With further reference to FIGS. 7 to 9, the shielding plates 30 are used for preventing crosstalk between adjacent sets of the terminals 20s, 20g, correspond to the insulative boards 10 and correspond to the sets of the terminals 20s, 20g. Each shielding plate 30 is mounted on one side of a corresponding insulative board 10 and has multiple current-path-interrupting holes 300. The current-path-interrupting holes 300 are defined through the shielding plate 30 and kept hollow without being inserted by objects. Furthermore, each shielding plate 30 is connected to the grounding terminals 20g of a corresponding set of the terminals 20s, 20g.

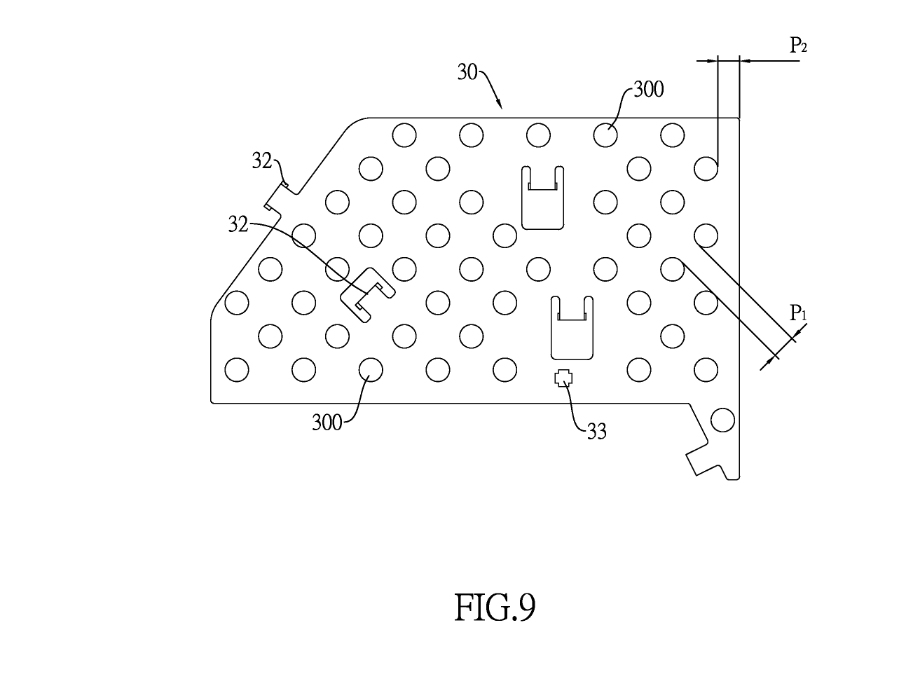

According to antenna effect, an exposed metal piece easily possesses antenna characteristics, collects electric charges to increase electric potential, and then generates current. The current easily runs along a sufficiently long path on the metal piece to cause high or low frequency signal interference. Therefore, forming the current-path-interrupting holes 300 on each shielding plate 30 cuts the longest current path along a diagonal line on the shielding plate 30 into much shorter paths between adjacent current-path-interrupting holes 300, which reduces and even prevents current paths and effectively reduce the antenna effect on each shielding plate 30. As shown in FIG. 9, a path P₁ between adjacent current-path-interrupting holes 300 are shorter than 0.9 mm, which is much shorter than the diagonal line of the shielding plate 30. A path P₂ between an edge of the shielding plate 300 and a nearest current-path-interrupting hole P₃ is shorter than 1 mm. Therefore, the shielding plates 30 effectively decrease antenna effect.

Furthermore, each shielding plate 30 of each set has at least one second engaging element 32, 33 that is engaged with the at least one of the first engaging elements 12, 13 of the corresponding insulative board 10.

The outer casing 40 covers the insulative boards 10 to combine the insulative boards 10 and has multiple socket holes 410. The socket holes 410 are defined in a front 41 of the outer casing 40 and respectively receive the electrical contacting sections 23 of the terminals 20s, 20g.

The rear assembling cover 50 is mounted on rear ends of the insulative boards 10 to ensure that the insulative boards 10 are combined and arranged abreast precisely.

In a preferred embodiment, each first engaging element 12, 13 is a recess or a protrusion, and each second engaging element 32, 33 is a protrusion or a recess corresponding to the recess or protrusion that is the first engaging element 12, 13.

In a preferred embodiment, each shielding plate 30 has a first connecting element 35 formed thereon. The first connecting element 35 may be a hooking tab. Each grounding terminal 20g has a second connecting element 25 formed thereon and connected to the first connecting element 35 on the shielding plate 30 that is connected to the grounding terminal. The second connecting element 25 may be a hooking hole hooked by the hooking tab. Furthermore, each insulative board 10 has multiple through holes 15 through which the first connecting element 35 extends.

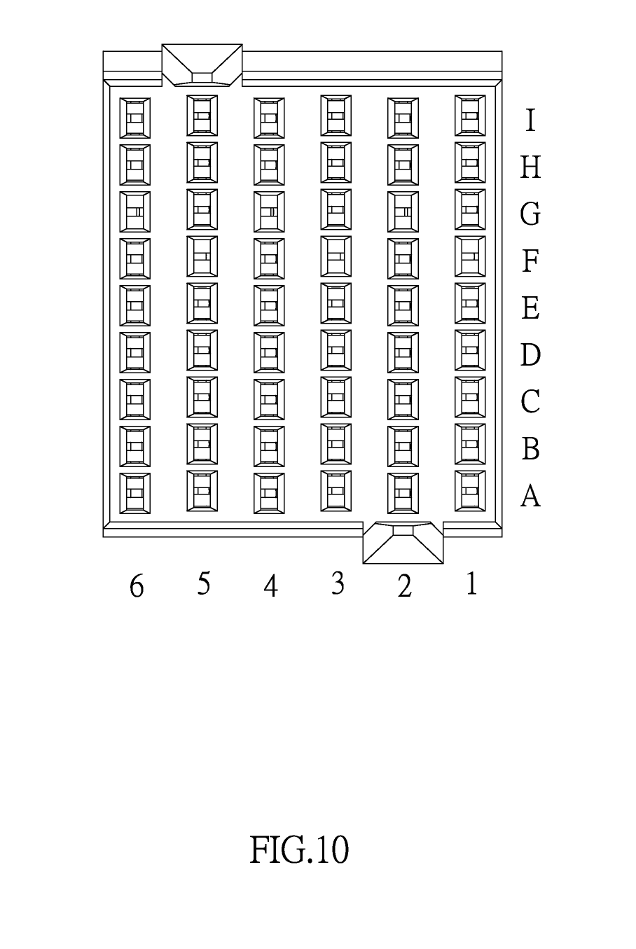

With further reference to FIG. 10, a signal test is implemented. According to the front view of the socket holes 410, the terminals 20 are arranged into an array with A to I rows and 1 to 6 columns. Crosstalk tests respectively between adjacent terminals 20 are implemented, for example, a crosstalk test of two terminals 20 located respectively on coordinates (A, 3) and (B, 3) (the two coordinates are abbreviated to AB3 and similar abbreviations will be done hereafter). The following comparison tables are for the receptacle connector of the present invention with the shielding plates 30 and a conventional receptacle connector without shielding plates.

TABLE 1
Proximal end crosstalk of signal terminal pairs:
Raising time: 55 ps(20-80%)
measurement of peak to peak variation employed

| Coordinates of | Proximal end | Proximal end | |
|---|---|---|---|
| signal terminals | crosstalk without | crosstalk with | |
| (adjacent signal | shielding | shielding | Difference |
| terminals) | plates (%) | plates(%) | value |
| AB3 | 1.48% | 1.04% | 0.38% |
| DE3 | 2.63% | 2.32% | 0.23% |
| GH3 | 1.83% | 1.78% | 0.13% |
| BC2 | 2.05% | 1.88% | 0.15% |
| EF2 | 2.92% | 2.24% | 0.52% |
| HI2 | 0.87% | 0.86% | 0.01% |

TABLE 2
Distal end crosstalk of signal terminal pairs:
Raising time: 55 ps(20-80%)
measurement of peak to peak variation employed

| Coordinates of | Distal end | Distal end | |
|---|---|---|---|
| signal terminals | crosstalk without | crosstalk with | |
| (adjacent signal | shielding | shielding | Difference |
| terminals) | plates (%) | plates(%) | value |
| AB3 | 1.08% | 0.98% | 0.10% |
| DE3 | 1.52% | 1.30% | 0.22% |
| GH3 | 0.96% | 1.30% | −0.34% |
| BC2 | 1.15% | 1.20% | −0.05% |
| EF2 | 1.72% | 1.16% | 0.56% |
| HI2 | 0.86% | 0.96% | −0.10% |

According to the aforementioned comparison tables, the crosstalk of most of the terminals 20s, 20g are lowered after using the shielding plates 30 so that the signal transmission efficiency and stability are improved.

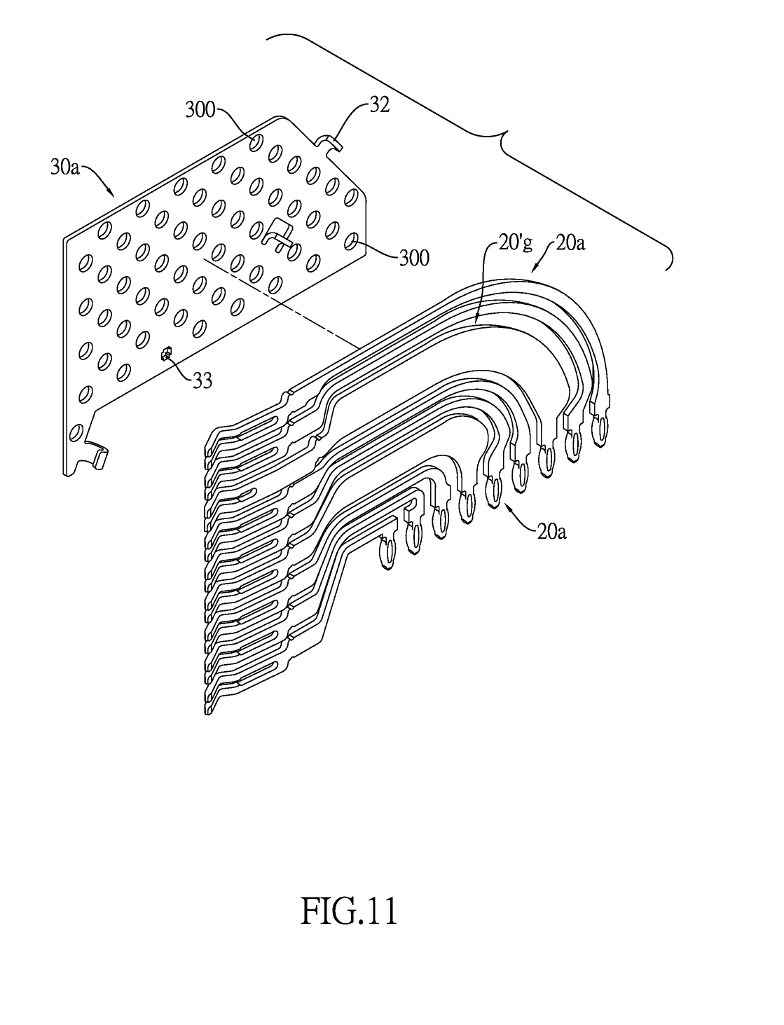

With further reference FIG. 11, another embodiment of the crosstalk-proof receptacle connector of the present invention has each shielding plate 30a unconnected to any one of the signal terminals 20s or grounding terminals 20′g. Therefore, each shielding plate 30a does not have any first connecting elements and each signal terminal 20s or grounding terminal 20′g does not have any second connecting element. However each shielding plate 30a still has the second engaging element 32, 33 for engaging the first engaging element 12, 13 of the insulative board 10.

According to the aforementioned description, the present invention has the following advantages.

1. Because each insulative board 10 is mounted with a shielding plate 30 on one side to alternately arrange the insulative boards 10 and the shielding plates 30, crosstalk between adjacent sets of terminals 20 is decreased.

2. The shielding plate 30 has multiple current-path-interrupting holes 300 to reduce and even prevent antenna effect on the shielding plate 30, which extremely suppresses crosstalk and improves efficiency and stability of signal transmission.

3. The first connecting element 35 of the shielding plate 30 is connected to the second connecting element 25 of the grounding terminal 20g so that the grounding effect is extended to direct the static electricity and signal noise likely causing crosstalk out of the receptacle connector to further improve signal transmission efficiency and stability.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A crosstalk-proof receptacle connector comprising:
multiple insulative boards arranged abreast;
multiple sets of terminals mounted respectively in and corresponding to the insulative boards, and each set including signal terminals and grounding terminals;
multiple shielding plates corresponding to the insulative boards and corresponding to the sets of the terminals, each shielding plate mounted on one of two opposite sides of a corresponding insulative board and having multiple current-path-interrupting holes defined through the shielding plate and kept hollow without being inserted by objects, and each shielding plate connected to the grounding terminals of a corresponding set of the terminals; and
an outer casing covering the insulative boards to combine the insulative boards.

2. The crosstalk-proof receptacle connector as claimed in claim 1, wherein
each insulative board has multiple first engaging elements formed on the insulative board; and
each shielding plate has at least one second engaging element engaged with the at least one of the first engaging elements of a corresponding insulative board.

3. The crosstalk-proof receptacle connector as claimed in claim 2, wherein
each first engaging element is a recess or protrusion; and
each second engaging element is a protrusion or recess corresponding to the recess or protrusion that is the first engaging element.

4. The crosstalk-proof receptacle connector as claimed in claim 3, wherein
each shielding plate has a first connecting element formed thereon;
each grounding terminal of a corresponding set of the terminals has a second connecting element formed thereon and connected to the first connecting element on the shielding plate that is connected to the grounding terminal; and
each insulative board has multiple through holes through which the first connecting element extends.

5. The crosstalk-proof receptacle connector as claimed in claim 4, wherein
the first connecting element is a hooking tab; and
the second connecting element is a hooking hole hooked by the hooking tab.

6. The crosstalk-proof receptacle connector as claimed in claim 5 further comprising a rear assembling cover mounted on rear ends of the insulative boards.

7. The crosstalk-proof receptacle connector as claimed in claim 6, wherein each terminal of each set has
a mounting section embedded in the corresponding insulative board;
an assembling section formed on and protruding downward from the mounting section; and
an electrical contacting section formed on and protruding forward from the mounting section.

8. The crosstalk-proof receptacle connector as claimed in claim 7, wherein each shielding plate is made of metal.

9. The crosstalk-proof receptacle connector as claimed in claim 8, wherein a path between adjacent current-path-interrupting holes are shorter than 0.8 mm.

10. The crosstalk-proof receptacle connector as claimed in claim 8, wherein a path between an edge of the shielding plate and a nearest current-path-interrupting hole is shorter than 1 mm.

11. A crosstalk-proof receptacle connector comprising:
multiple insulative boards arranged abreast;
multiple sets of terminals mounted respectively in and corresponding to the insulative boards, and each set including signal terminals and grounding terminals;
multiple shielding plates corresponding to the insulative boards and corresponding to the sets of the terminals, each shielding plate mounted on one of two opposite sides of a corresponding insulative board and having multiple current-path-interrupting holes defined through the shielding plate and kept hollow without being inserted by objects; and
an outer casing covering the insulative boards to combine the insulative boards.
